(19) United States
(12) Patent Application Publication
(10) Pub. No.: US 2007/0294134 A1
(43) Pub. Date: Dec. 20, 2007

(54) A MULTIPLE ENTITY PURCHASE AND SALE TRANSACTION SYSTEM

(76) Inventor: Juxing Yang, Boxborough, MA (US)

Correspondence Address: JUXING YANG, 115 COLONIAL RIDGE DRIVE, BOXBOROUGH, MA, 01719, US

(21) Appl. No.: 11/424,538

(22) Filed: Jun. 15, 2006

(51) Int. Cl. G06Q 30/00

(52) U.S. Cl. 705/26

(57) ABSTRACT

A multiple entity purchase and sale transaction system enables shoppers and sellers to conduct business on internet using shopping groups. Group shopping allows sellers to sell goods and services to groups of shoppers at low prices. The multiple entity purchase and sale transaction system can be implemented as a group shopping web site. The group shopping web site allows unrelated shoppers to create, join, and check out a shopping group during open enrollment period. Sellers are allowed to provide bids to a shopping group during the open enrollment period of the shopping group. At the end of open enrollment period, a group shopping administrator selects an accepted seller. Finally the group shopping web site links shoppers in the shopping group and the accepted seller together so that shoppers can pay the accepted seller for goods and services and the accepted seller can provide goods and services to shoppers.

### CROSS REFERENCE TO RELATED APPLICATIONS

Not Applicable

### FEDERAL RESEARCH STATEMENT

Not Applicable

### FIELD OF INVENTION

This invention is related to purchase and sale transactions among multiple entities, specifically to internet on-line transactions between groups of shoppers and sellers.

### PRIOR ARTS

Today internet on-line transactions are as common as traditional retail transactions. Typically in an on-line transaction environment, a seller lists items for sale on a web site. A shopper accesses the web site and selects an item to buy. If the shopper decides to purchase the item, the shopper goes through a check-out process to pay for the item. During the check-out process, the shopper provides the seller his billing and shipping information. After the seller receives the payment using shopper's billing information, the seller delivers the item to the shopper using shopper's shipping information. At this point the purchase and sale transaction is complete. This process is similar to traditional retail purchase and sale transactions except that on-line transactions are done on web sites. During this process, two entities are involved: the shopper and the seller. Although this process is used in the majority of internet purchase and sale transactions, it does not satisfy the need of multiple shopping entities and does not provide maximum leverage for shoppers.

### OBJECTS AND ADVANTAGES

This invention describes a new process that allows multiple shoppers shop together as a group electronically. This group is called a shopping group. This method of shopping is called group shopping. In this invention, a shopper or a seller is considered as an entity. Since a shopping group involves multiple shoppers and sellers, this purchase and sale process is called a multiple entity purchase and sale transaction.

Sellers often give volume discounts to groups of shoppers. Sellers' costs of doing business are significantly lower when they make volume sales. This is because volume sales improve sellers' cash flow, reduce uncertainty of merchandise ordering, and lower the risk of accumulating unsold merchandise. Shopping groups take advantage of these volume discounts. Shopping groups can be formed to shop for goods as well as services or anything where a volume discount may apply. Traditionally shopping groups are formed through word of mouth, acquaintance, associations, etc. The scope of traditional shopping groups is limited. Internet opens a door for people around the world to get together and form shopping groups. Internet dramatically increases the purchasing power of unrelated individual shoppers by grouping them together.

Group shopping requires following steps:

(1) Designate a product with a detailed description.

(2) Form a shopping group for the product.

(3) Find a seller who is willing to give a volume discount.

(4) Shoppers in the shopping group agree to the seller's discounted price.

(5) The seller accepts the shopping group.

(6) The seller takes payments and delivers products to all shoppers in the group.

To guide a shopping group through these steps, a special entity is needed to coordinate the activities of the shopping group. This entity is called a shopping group administrator. The shopping group administrator keeps track of shoppers in the shopping group, presents the shopping group to various sellers, finalizes the deal, collects payments from shoppers, and assists sellers to deliver products to shoppers.

Generally all shoppers in a shopping group are required to purchase the exact same goods and services. It is possible to form a shopping group that have a vague product definition. For example, an insurance company may offer members of an association discounts without specifying an exact insurance policy. The members of that association are actually in a shopping group. For the purpose of describing this invention, we assume shoppers in a shopping group purchase the exact same goods and services.

Since group shopping requires coordination of many shoppers and sellers. There are more steps in shopping group transactions than steps in traditional transactions. Generally shoppers using group shopping get better prices than shoppers using traditional internet shopping method. The drawback is that group shopping takes longer than traditional internet shopping. This invention describes approaches to minimize complexity of group shopping.

Shopping groups can be created by shoppers as well as sellers, shopping group administrators, or other authorized entities. When an entity creates a shopping group, the entity needs to enter detailed description of goods and services into the shopping group. A lock-in date must be set. The period between the creation of a shopping group and the lock-in date is open enrollment period. During this period other shoppers can join the shopping group. After the lock-in date, the shopping group is closed to new shoppers. The shopping group lock-in date signals the end of the open enrollment period.

Once a shopping group is created, other shoppers may join the shopping group. To join a shopping group, a shopper must provide shopper's identification information and specify “X” number of units of goods and services that the shopper is intended to purchase, where “X” is a non-negative integer. The shopper's identification information is used to associate shopper's order with the shopper. The identification information could be as simple as a number so that a shopper may remain anonymous. In this invention, the number of units of goods and services is called as ordered quantity or simply orders. By joining the shopping group, shoppers express the interest of purchasing orders of goods and services.

Traditionally sellers use a so-called sequential model to do business with shopping groups. In the sequential model, a shopping group is presented to sellers after the end of the open enrollment period. Sellers provide bids to shopping groups. A bid contains a price and a requirement of minimum number of shoppers. When shoppers in a shopping group are presented with the bid, shoppers may accept or reject the bid. If the number of shoppers who accept the bid meets the requirement for minimum number of shoppers, shoppers who accept the bid pay the seller the bid price for goods and services in the shopping group. After receiving payments, the seller delivers goods and services to shoppers. If not enough shoppers accept the bid, the shopping group is presented to sellers again. Above process repeats until a bid is accepted or number of iterations reaches a preset limit.

It is difficult to apply the sequential model in an on-line environment because of limitations of the model. Due to the long shopping cycle of the sequential model, many shoppers may find that savings from group shopping may not worth the time that they need to wait for the group shopping processing to complete.

In this invention a new concurrent model is described. In the concurrent model, a shopping group is presented to sellers before the end of the open enrollment period. Sellers are allowed to provide bid prices during the open enrollment period. During the open enrollment period shoppers may join and check out the shopping group. Joining a shopping group does not obligate a shopper to purchase goods and services in the shopping group. Checking out a shopping group does obligate a shopper to purchase goods and services in the shopping group. When a shopper checks out a shopping group, the shopper agrees to the current bid or the final accepted bid which is always no worse than the current bid. During the check-out process, the shopper provides his billing and shipping information to a shopping group administrator. After a shopper checks out, the shopper cannot leave the shopping group. During the open enrollment period, a shopping group may contain an accepted seller whose bid is currently accepted by the shopping group. The accepted seller's bid is called the accepted bid or the current bid. If a new seller wants to do business with the shopping group, the new seller must provide a better bid than the accepted bid. If the new bid is accepted, the new seller becomes the accepted seller and the new bid becomes the accepted bid. At the end of open enrollment period, the accepted seller must decide to accept or reject the shopping group. The accepted seller is allowed to reject the shopping group because the accepted seller does not know the exact number of checked out shoppers during the open enrollment period. If an accepted seller rejects a shopping group, the shopping group is automatically dissolved. If an accepted seller accepts a shopping group, the accepted seller is presented with billing and shipping information of checked-out shoppers. The accepted seller is required to accept the payments and deliver goods and services to checked-out shoppers.

When a shopper joins a shopping group, the shopper is called an active shopper in the shopping group. When the shopper checks out the shopping group, the shopper is called a checked-out shopper in the shopping group. The distinction of these two types of shoppers is important. An active shopper is interested in goods and services in a shopping group. Most likely the accepted bid price is not good enough for the active shopper to check out. This information is very valuable for sellers preparing for a bid to the shopping group.

A shopping group may be in one of the following states: OPEN, LOCKED, ACCEPTED, REJECTED, PROCESSED, and CLOSED. If a shopping group is in the OPEN state, shoppers may join the shopping group or check out the shopping group. Active shoppers are allowed to change the ordered quantity. Sellers are allowed to provide bids to the shopping group. A shopping group changes from the OPEN state to the LOCKED state at the end of the open enrollment period. If a shopping group is in the LOCKED state, shoppers are not allowed to check out and new bids from sellers are not accepted. Only the accepted seller is allowed to either accept or reject the shopping group. If the accepted seller accepts the shopping group, the state of the shopping group is changed to ACCEPTED. If the accepted seller rejects the shopping group, the state of the shopping group is changed to the REJECTED state. If a shopping group is in the ACCEPTED state, the accepted seller needs to process the payments from the checked-out shoppers and deliver goods and services to the checked-out shoppers. After the accepted seller has completed the proceeding tasks, the state of the shopping group is changed to the PROCESSED state. At this point the shopping group may move to the CLOSED state after the accepted seller completes any remaining tasks if required by the shopping group administrators.

Sellers may browse or search shopping groups. Shopping group administrators may notify sellers when new shopping groups are created. If a seller is interested in a shopping group, the seller is presented with information regarding the shopping group such as shopping group description, lock-in date, total number of ordered quantities and total number of checked-out ordered quantities, current accepted bid price, and shopping group state. Sellers may use this information to compute a bid price. If a seller decides to bid to a shopping group, the bid must be better than the current bid. Normally it means that the bid price is lower than the current price.

When a shopping group receives a new bid, shoppers and shopping group administrators may decide to accept or reject the bid. For simplicity, the shopping group administrator may be granted as the sole entity to determine whether a new bid is acceptable. In determining if a bid is acceptable, the shopping group administrator may consider monetary factors and non-monetary factors such as the bid price, seller's bid priority, and seller's customer satisfaction rating. The collection of these factors and the seller's bid is called a formulated bid. The shopping group administrator uses the formulated bid to evaluate a seller's bid. Therefore a seller's bid price that is lower than the current bid price does not necessarily mean that the bid will be accepted.

Key features of the concurrent model are: (1) shoppers are allowed to join and check out a shopping group during the open enrollment period; (2) sellers are allowed to bid the shopping group during the open enrollment period. There is a strong correlation between number of checked-out shoppers and the current bid price. The dynamic nature of these features enables the concurrent model to have much shorter shopping cycle than the sequential model. The shopper check-out feature during the open enrollment period makes the concurrent model almost as convenient as traditional internet shopping. With this feature a shopper can complete shopper's tasks involved in a shopping process as soon as the shopper sees an acceptable price in the shopping group. The concurrent model also provides a better shopping group control than the sequential model. With the sequential model shoppers may leave a shopping group at any time. If too many shoppers leave a shopping group, the shopping group is in danger of being dissolved. In the concurrent model, shoppers are allowed to check out during the open enrollment period. At the end of open enrollment period a shopping group would contain at lease checked-out shoppers. This ensures the stability of a shopping group.

### SUMMARY OF INVENTION

In accordance with this invention, a system allows multiple entities to do coordinated purchase and sale transactions and to provide cost-savings to all parties. Specifically shoppers may create and join shopping groups electronically and sellers may make deals with these shopping groups electronically.

### BRIEF DESCRIPTION OF DRAWINGS

### Brief Description of Figures

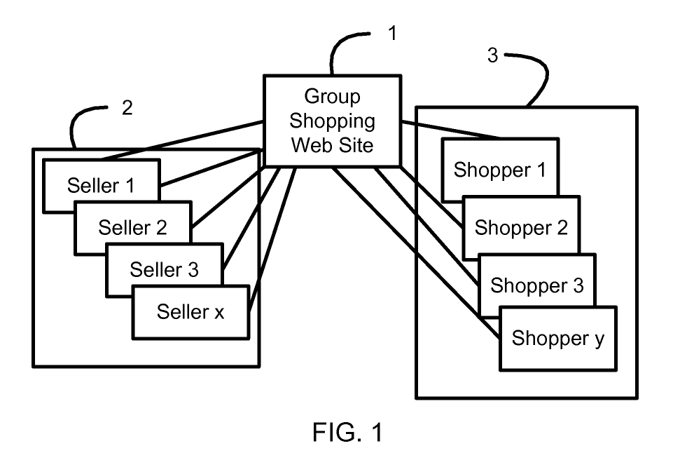

FIG. 1 shows an internet system with a group shopping web site, shoppers, and sellers.

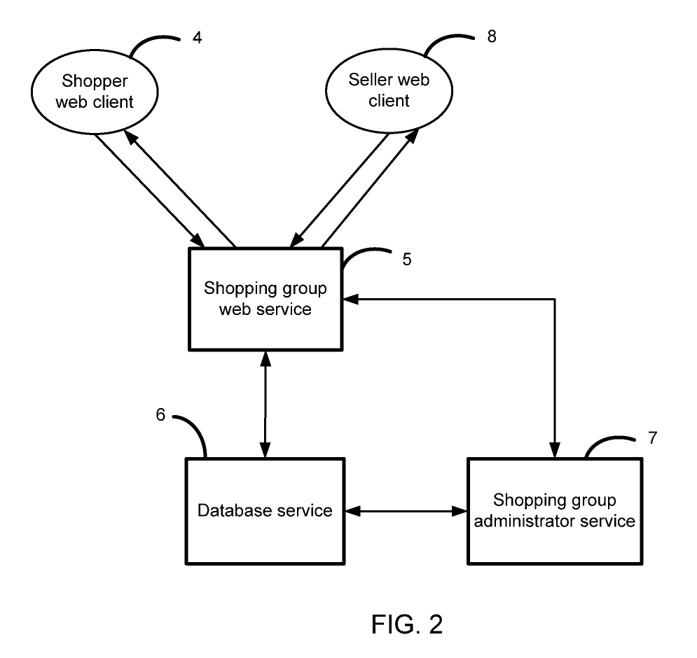

FIG. 2 shows a typical group shopping web services.

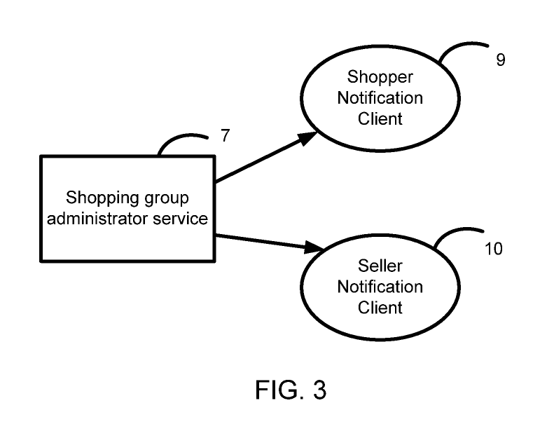

FIG. 3 shows a typical group shopping notification service.

### BRIEF DESCRIPTION OF REFERENCE NUMERALS

1. Group shopping web site with one or more web servers.
2. Sellers using any web browsers or equivalent interact with a group shopping web site.
3. Shoppers using any web browsers or equivalent interact with a group shopping web site.
4. Web clients used by shoppers. These are typically web browsers.
5. Web service at a shopping web site. This is typically a HTTP/HTTPS service.
6. Database for managing data used in this shopping group web site.
7. Shopping group administrator service for background processing and resource intensive processing.
8. Web clients used by sellers. These are typically web browsers.
9. Notification clients used by shoppers. These are typically email programs.
10. Notification clients used by sellers. These are typically email programs.

### Definition of a Shopping Group

A shopping group consists of several required external elements. First it needs a detailed description of a unique set of goods and services. Since many shoppers may join a shopping group, the shopping group description should be clear enough so that any two shoppers can identify the same goods and services based on the shopping group description. Second, the goods and services must be measurable in monetary terms. Third, the unit of goods and services must be clearly defined. A shopping group needs an open enrollment period or a lock-in date. During this open enrollment period, shoppers may join the shopping group and sellers may provide a bid or a price for the shopping group. Some goods and services may depend on geographical locations. Therefore, shopping groups may include geographical location information indicating that only shoppers whose shipping addresses are in certain geographical locations may join the shopping group. For example, a shopping group may specify that goods and services are only available at certain zip codes or area codes. Most shopping groups have a title.

In addition to external elements, shopping group data structure may contain internal elements such as a shopping group identifier and shopping group state. Shopping group internal elements are used by shopping group administrators to manage shopping groups.

### Shopping Group Administrator

A shopping group administrator facilitates interactions between shoppers and sellers and controls shopping groups. For a shopping group, the shopping group administrator maintains the shopping group information and manages the shopping group state. When appropriate events occur, the shopping group administrator changes the shopping group state. For example, at the end of the open enrollment period of a shopping group, the shopping group administrator changes the shopping group state to LOCKED. When a shopper joins the shopping group or checks out the shopping group, the shopping group administrator collects shopper information such as number of ordered quantities and billing and shipping information. The shopping group administrator manages bid process. The shopping group administrator may accept or reject a seller's bid. The shopping group administrator interacts with shoppers and sellers through one or more communication means such as the shopping group web site and email. For example, when a new bid is accepted in a shopping group, the shopping group administrator may notify the new bid to all shoppers in the shopping group. Basically shopping group administrators run shopper group web sites.

### Creation of Shopping Groups

Any one who interacts with a shopping group web site may create a shopping group. Generally shoppers, sellers, and shopping group administrator create a shopping group. Since the more shoppers in a shopping group the better the price is, it is preferable for shoppers to join an existing shopping group with same goods and services.

### Joining and Checking Out a Shopping Group

In order to join a shopping group a shopper must provide shopper's identification and specify ordered quantity of goods and services in the shopping group that the shopper is intended to purchase. In addition to the ordered quantity, shoppers may provide other information that may not change the total cost of goods and services. For example, if a product has several color selections and the price of the product is independent of color selections, a shopper may select colors of the product when the shopper joins the shopping group. Joining a shopping group does not obligate the shopper to purchase goods and services in the shopping group. Shoppers' interests in the shopping group provide important information for sellers to set a price for the shopping group. Shoppers may change the ordered quantity during the open enrollment period and before checking-out.

If a shopper considers the accepted bid in a shopping group acceptable, the shopper may check out the shopping group. Check-out means that the shopper confirms to the shopping group administrator that the shopper is committed to purchase the number of units of goods and services in the shopping group. If a shopper checks out a shopping group, the shopper cannot reverse the decision or change the number of units. The shopping group administrator may ask the shopper to provide a guarantee at the check-out time to back up the shopper's commitment. The guarantee could be shopper's credit card information. If the shopper rescinds the check-out decision, the shopping group administrator may charge the shopper's credit card for the ordered quantity of goods and services and use the proceeds to compensate the final accepted seller. Note that the final bid price could be lower than the bid price when the shopper checks out. All checked-out shoppers are offered the final bid price and the final accepted seller regardless when they check out.

### Providing a Bid

During the open enrollment period, a seller may bid a shopping group by setting a price for a unit of goods and services in the shopping group. The seller's bid represents the seller's desire to provide goods and services for a given price per unit to all shoppers in the shopping group. The seller may lower the bid price. A different seller may provide a new bid. A seller's bid does not obligate the seller to provide the goods and services at the bid price because the seller does not have the final number of units that shoppers have checked out to purchase. A shopping group administrator may accept or reject a seller's bid.

### Bid Formats

A seller's bid must be clear and concise so that shoppers or shopping group administrators can evaluate bids without ambiguity. Valid bids must form a sequential ordered set. For any two bids “a” and “b”, “a” can be better than “b”, equal to “b”, or worse than “b”. For any three bids “a”, “b”, and “c”, if “a” is better than “b” and “b” is better than “c”, then “a” must be better than “c”.

Normally a bid is a price per unit of goods and services in a shopping group. However this is not required. A bid may not be in absolute monetary term. A bid could be a percentage of the value of goods and services. For example, in real estate business, a bid could be the percentage of final selling price of a house.

In order for a shopping group administrator to compare bids, all sellers must submit bids in the same format. In a typical transaction, a shopper's payment for goods and services includes price of goods and services, shipping and handling, and taxes. Based on this fact, a simple bid format that satisfies bid format requirements includes three price elements: the unit price of goods and services, maximum total unit cost of goods and services, and the minimum total unit cost of goods and services. The total unit cost includes the unit price and any additional charges on a per unit basis. For bid “a” to be better than bid “b”, all three price elements of bid “a” must be lower than those of bid “b”.

### Post Open Enrollment Period

When the open enrollment period of a shopping group ends, shoppers who have not checked out are excluded from the shopping group. No shoppers can check out after the end of the open enrollment period. The accepted seller must decide to accept or reject the shopping group. If the seller accepts the shopping group, the seller must deliver the goods and services at the accepted bid to all checked-out shoppers. If the seller rejects the shopping group, the shopping group is dissolved. The most common reason for a seller to reject a shopping group is that the number of checked-out shoppers is below seller's expectation. If the seller accepts the shopping group, the shopping group administrator may collect service fees from the seller.

### GROUP SHOPPING WEB SITE EMBODIMENT

Although multi-entity transaction service such as group shopping can be implemented in many different ways, an internet web site is a simple approach. FIG. 1 shows that shoppers and sellers interact with a group shopping web sever. Shoppers and sellers may use web browsers to interact with the web server. There is no single way to implement a shopping group service. Comparing with more complicated web services, shopping group service is relatively simple to implement. Any competent web site developer can come up with an implementation. In this invention a sample implementation is described.

In this invention a web site is an information processing center. A group shopping web site means a web site with features as described in this invention. Typically a web site is a computer server providing HyperText Transport Protocol (HTTP) service. A web server generally provides additional services such as HTTPS which is a secure communication protocol.

To support group shopping on a web site, the web site needs to provide essential services so that shoppers, sellers, and administrators can create shopping groups, shoppers can join shopping groups, sellers can bid on shopping groups, and administrator can manage shopping groups. The web site may include optional features to help shoppers and sellers in the shopping process and the bidding process. One example of these optional features is that the web site may allow shoppers to store billing and shipping information. As most shopping web site have, a database service is needed to support the web site and store user inputs.

A simple implementation of shopping group web services is shown in FIG. 2. In this implementation, a shopping group web service (5) acts as a web server. The shopping group web service processes HTTP or HTTPS requests from shopper web clients (4) and seller web clients (8) and sends HTTP or HTTPS responses back to shopper web clients and seller web clients. Typically shopper and seller web clients are web browsers. When the shopping group web service processes shopper web clients and seller web clients, it may need to store and retrieve information to and from a database service (6). A shopping group administrator service (7) is to do background tasks and to off-load some tasks from the shopping group web service. FIG. 3 shows that the shopping group administrator may send notifications to shoppers and sellers regarding shopping groups. These notifications are sent to shoppers' notification clients (9) and sellers' notification clients (10). Notification clients are typically email programs or email web clients.

A group shopping web site needs to provide a shopping group creation form for creating a shopping group. The shopping group creation form includes an entry for shopping group title, an entry for shopping group description, an entry for lock-in date, and an optional entry for identification of geographical locations. When a shopper creates a shopping group, the shopping group creation form allows the shopper to enter the number of ordered units of goods and services. When a seller creates a shopping group, the shopping group creation form allows the seller to enter a bid. When the web site receives the shopping group creation form, the web site assigns a unique id for the shopping group and stores shopping group information in the database.

The shopping group web service may contain a hierarchical category system to facilitate easy browsing of shopping groups. The shopping group web service could include a search function that allows anyone to search for shopping groups using keywords.

The shopping group web service displays a shopping group in a shopping group display page. The shopping group display page should display shopping group title, shopping group description, lock-in date, and the shopping group state. The shopping group display page may display additional information such as the accepted bid, total number of participants, total number of ordered units, and total number of checked-out units.

The web site provides a shopper enrollment form. The shopper enrollment form allows a shopper to join a shopping group by providing the shopper's identification and specifying the number of ordered units. A typical form of shopper's identification is shopper's email address. When the web site receives this form, it associates the shopper with the shopping group. The shopper enrollment form can also be used to update active shopper's ordered quantity if the shopper is an active member in the shopping group.

The web site provides a shopper check-out form. The shopper check-out form allows a shopper to submit billing and shipping information. After receiving the shopper check-out form, the web site changes the shopper type from active to checked-out and stores the billing and shipping information.

The web site provides a seller bid form. A seller can use the seller bid form to submit a bid to a shopping group by specifying the three elements of a bid price. When the web site receives the seller bid form, it first computes a formulated bid and then uses the formulated bid to check if the new bid is better than the accepted one. If the new bid is better, the web site stores the new bid as the accepted bid.

The web site provides a seller acceptance form. At the end of open enrollment period, the accepted seller is presented with a seller acceptance form. The seller submits this form to the web site to indicate if the seller accepts or rejects the shopping group. When the web site receives the seller acceptance form, the web site stores the seller's decision and changes the shopping group state accordingly. If the seller accepts the shopping group, the web site returns a web page with links to checked out shoppers billing and shipping information.

The shopping group web service uses a shopping group administrator service to manage shopping groups. The shopping group administrator service is an independent service from the shopping group web service. The main task of the shopping group administrator service is to check if shopping group's open enrollment period ends and if a shopping group needs to change state. When the shopping group administrator service finds a shopping group lock-in date has just passed, it changes the shopping group state to LOCKED state and notifies the accepted seller and checked-out shoppers via email. The web service may perform some administrator tasks. If an administrator task requires long processing time, that task is off-loaded to the shopping group administrator service. For example, if the shopping group web site receives and accepts a new bid for a shopping group, the shopping group administrator may send a notification of this new bid to all shoppers in the shopping group. Since notification of all shoppers in a shopping group may take long time, this task may be off-loaded to the shopping group administrator service.

The shopping group administrator service is a computer program that runs in the background. At a given time interval, it queries the shopping group database and looks for shopping groups which lock-in date has passed the current date. The shopping group administrator service changes the state of these shopping groups to LOCKED. When the lock-in date is near, the shopping group administrator may send email reminders about the lock-in date to shoppers and the accepted seller.

The shopping group administrator service interacts with the shopping group web service through a communication channel. A socket based communication can be used. The shopping group administrator service listens for requests from the shopping group web service. When the shopping group web service needs delegate a task to the shopping group administrator services, it sends a request to the shopping group administrator service via the communication channel. When a seller submits a bid, the shopping group web service may send this bid to the shopping group administrator service. The shopping group administrator service decides whether to accept or reject the bid. If the bid is accepted, the shopping group administrator may send email notification to all shoppers so that shoppers may evaluate this bid and take action accordingly. All shopping group administrator tasks can be accomplished either using the background processing or requests from the communication channel.

### CONCLUSION, RAMIFICATIONS, AND SCOPE OF INVENTION

A web-based shopping group system is described in this invention. The system provides a forum for unrelated shoppers to form shopping groups and sellers to sell goods and services to these shopping groups.

What is claimed is:

1. An information processing center comprised of:
a shopping group creation component for anyone to create a shopping group with an open enrollment period;
a shopping group shopper control component for shoppers to join or check out shopping groups during said open enrollment period;
a shopping group seller control component for sellers to provide bids to shopping groups during said open enrollment period;
a shopping group presentation component for anyone to browse, search, or display a shopping group;
a shopping group administration component for controlling shopping groups so that shopping groups can be moved from open state to locked-in state, accepted state, processed state, and eventually closed state and for processing shopping group changes;
whereby shopping groups can be created;
whereby shoppers can join and check out shopping groups;
whereby sellers can provide bids to shopping groups;
whereby shoppers get better prices as a group and sellers get higher profits and lower costs.

2. The information processing center of claim 1 wherein:
the shopping group creation component can create a shopping group with a title, a description of goods and service, a definition of an unit of goods and services, a means to specify open enrollment period, and optionally geographical locations where goods and services are available;
whereby a shopping group can be created without ambiguity;
whereby sellers can provide bid prices to a shopping group.

3. The information processing center of claim 1 wherein:
the shopping group shopper control component further comprising a means for shoppers to enter shoppers' identification information and to enter or change ordered quantities and zero or more attributes of goods and services that do not change total costs in shopping groups;
whereby shoppers can join shopping groups by specifying ordered quantities in shopping groups;
whereby shoppers can order goods and services specific to their needs.

4. The information processing center of claim 3 wherein:
the shopping group shopper control component further comprising a means for shoppers to check out a shopping group by providing billing information and shipping information to said shopping group or a shopping group administrator;
whereby shoppers can check out shopping groups and wait to receive delivery of goods and services.

5. The information processing center of claim 1 wherein:
the shopping group seller control component further comprising a means for sellers to provide bids to shopping groups;
wherein bids for a shopping group form a totally ordered set with reflexivity, anti-symmetry, transitivity, and comparability;
whereby a shopping group administrator can select a bid objectively;
whereby a shopping group can get the best bid.

6. The information processing center of claim 5 wherein:
a bid is comprised of one or more monetary factors and zero or more non-monetary factors;
whereby said bid can be formulated so that a small bid provides a better value to shoppers than a large bid;
whereby a shopping group can get the best bid.

7. The information processing center of claim 5 wherein:
a bid comprises an unit price, a maximum total price, and a minimum total price;
wherein the total price is the price that a seller charges a shopper for an unit of goods and services in a shopping group including the unit price and other fees;
wherein the unit price is less than or equal to the minimum total price and the minimum total price is less than or equal to the maximum total price;
whereby different shoppers may pay different total price;
whereby shoppers know the range of total prices;
whereby a shopping group administrator can select the best bid.

8. The information processing center of claim 2 wherein:
the shopping group presentation component further comprising a means to display shopping group information including one or more of factors including shopping group title, shopping group description, shopping group unit definition, shopping group geographical locations, shopping group open enrollment period, shopping group total shopper count, shopping group checked-out shopper count, shopper status in the shopping group, shopping group status, shopper ordered quantity, accepted shopping group seller, and accepted bid information;
whereby shoppers can use this information to determine further action;
whereby sellers can use this information to determine further action.

9. The information processing center of claim 1 wherein:
the shopping group administration component further comprising a means to move a shopping group from open state to locked-in state at the end of open enrollment period of said shopping group, to move said shopping group from locked-in state to accepted state after the accepted seller accepts the said shopping group, to move said shopping group from accepted state to processed state after the accepted seller delivers goods and services to checked-out shoppers, and to move said shopping group from processed state to closed state after a shopping group administrator completes all tasks related to said shopping group;
whereby shopping groups can complete shopping group cycle.

10. The information processing center of claim 9 wherein:
the shopping group administrator component further comprising a means to compare seller's bids and accept or reject sellers' bids based on zero or more additional factors;
whereby a shopping group can select the best bid.

11. The information processing center of claim 1 wherein:
the shopping group administrator component further comprising a notification means for informing shoppers, sellers, and shopping group administrators of any changes in shopping groups;
whereby shoppers, sellers, and shopping group administrators can take actions regarding changes in shopping groups.

12. The information processing center of claim 11 wherein:
the notification system uses emails as a notification means;
whereby shoppers, sellers, and shopping group administrators receive email notifications regarding any changes in shopping groups.

13. The information processing center of claim 10 wherein:
the shopping group administrator component further comprising a means to allow an accepted seller to accept or reject a shopping group at the end of the shopping group open enrollment period;
whereby a seller can accept or reject a shopping group.

14. The information processing center of claim 10 wherein:
the shopping group administrator component further comprising a means for an accepted seller to receive checked-out shoppers' payments for goods and services and to assist said accepted seller to deliver goods and services to said checked-out shoppers;
whereby said accepted seller gets paid and checked-out shoppers get goods and services.

15. The information processing center of claim 14 wherein:
the shopping group administrator provides checked-out shoppers' billing and shipping information to an accepted seller;
whereby said seller can receive payments and deliver goods and services to shoppers.

16. The information processing center of claim 1 further comprising:
a means to browse and search shopping groups;
whereby shoppers can find existing shopping groups to join;
whereby sellers can find existing shopping groups to bid.

17. The information processing center of claim 1 wherein:
the information processing center is an internet web site;
whereby shopping groups are listed and accessed on a web site;
whereby shoppers and sellers can access shopping groups using web browsers.

18. A method for creating and processing shopping groups by shoppers, sellers, and shopping group administrators, the method comprising the steps of
creating a shopping group by shoppers, sellers, or a shopping group administrator and starting an open enrollment period;
displaying said shopping group information to shoppers, sellers, and said shopping group administrator;
joining said shopping group by shoppers during said open enrollment period;
providing bids to said shopping group by sellers during said open enrollment period;
accepting a seller's bid by said shopping group administrator during said open enrollment period;
checking out said shopping group by shoppers during said open enrollment period and providing billing information and shipping information to said shopping group administrator;
locking said shopping group and ending the open enrollment period by said shopping group administrator at the end of said open enrollment period;
accepting or rejecting said shopping group by the final accepted seller after said shopping group is locked;
collecting payment from shoppers by said shopping group administrator or said final accepted seller;
delivering goods and services described in said shopping group to checked-out shoppers by said final accepted seller if said final accepted seller accepts said shopping group;
whereby a shopping group is created and processed.

19. The method for creating and processing shopping groups by shoppers, sellers, and shopping group administrators of claim 18, further comprising the step of:
dissolving a shopping group if a final accepted seller rejects said shopping group;
whereby the final accepted seller may reject a shopping group.

20. The method for creating and processing shopping groups by shoppers, sellers, and shopping group administrators of claim 18, further comprising the steps of:
notifying shoppers new bids when a shopping group administrator receives a new bid;
notifying the final accepted seller when a shopping group is locked by a shopping group administrator.
notifying checked-out shoppers when the final accepted seller accepts a shopping group;
whereby shoppers and sellers are informed about shopping group changes.
